(19) United States
(12) Patent Application Publication
(10) Pub. No.: US 2016/0232542 A1
(43) Pub. Date: Aug. 11, 2016

(54) FORECASTING DEMANDS FOR EQUIPMENT BASED ON ROAD SURFACE CONDITIONS

(71) Applicant: CATERPILLAR INC., Peoria, IL (US)

(72) Inventors: Sanat Arun TALMAKI, Peoria, IL (US); Zachary Steven BIRKY, Washington, IL (US)

(73) Assignee: CATERPILLAR INC., Peoria, IL (US)

(21) Appl. No.: 14/617,276

(22) Filed: Feb. 9, 2015

(51) Int. Cl. G06Q 30/02

(52) U.S. Cl. CPC G06Q 30/0202

(57) ABSTRACT

Computer systems and computer-implemented methods forecast demand for road repair equipment and implement actions based on the forecasted demand. The computer systems may include a processor configured to collect road condition data for a road in one or more locations, collect econometric data related to one or more entities responsible for maintenance of the road in the one or more locations, and collect data related to historical responsiveness of the one or more entities in taking actions related to the maintenance of the road. The processor may identify one or more potential customers and a potential demand for certain types and respective quantities of the road repair equipment from the road condition data, the econometric data and the historical responsiveness data, and implement one or more of manufacturing decisions, inventory management decisions, dealer actions, and direct customer interactions based on the potential demand.

### TECHNICAL FIELD

This disclosure relates generally to forecasting demands for equipment and, more particularly, to forecasting demands for equipment based on road surface conditions.

### BACKGROUND

Organizations, such as those that produce, buy, sell, and/or lease machines, may desire to forecast the demand for the machines and parts associated with the machines. For example, an organization that manufactures one or more machines that are used in making and maintaining roads may desire accurate forecasts of demands for the machines and the parts constituting the machines. This type of information could be valuable in giving the organization a competitive advantage by allowing for accurate planning of the organization's facilities and production schedules for the machines and the parts, as well as allowing various marketing and sales organizations to improve and target their marketing and sales efforts related to the machines. Deteriorating conditions of roads and other infrastructure in this country and elsewhere, as well as increasing demands for new roads and infrastructure in developing areas of the world are potential sources of increased demand for the machinery used in these types of applications.

U.S. Patent Publication No. 2014/0160295 (the '295 publication) to Kyomitsu et al. is directed to systems and methods of detection and notification of potential road conditions. In particular, the '295 publication discloses a method including receiving road condition data from one or more vehicles. The data is identified as being associated with the probability of a potential road condition. Data received from a second vehicle is also used to change the probability of the potential road condition. Notifications of the potential road conditions are provided to one or more other vehicles. While the '295 publication may provide drivers with enhanced awareness of potential detrimental road conditions, the system and method of the '295 publication does not provide any useful information to the organizations that produce, buy, sell, or lease the machinery used in repairing the damaged roads or other infrastructure.

The disclosed systems and methods are directed to solving one or more of the problems set forth above and/or other problems of the prior art.

### SUMMARY

In one aspect, the present disclosure is directed to a computer system for forecasting demand for road repair equipment and implementing actions based on the forecasted demand. The computer system may include at least one processor configured to collect road condition data for a road in one or more locations, collect econometric data related to one or more entities responsible for maintenance of the road in the one or more locations, and collect data related to historical responsiveness of the one or more entities in taking actions related to the maintenance of the road. The at least one processor may also be configured to identify one or more potential customers and a potential demand for certain types and respective quantities of the road repair equipment from the road condition data, the econometric data and the historical responsiveness data. The at least one processor may be still further configured to implement one or more of manufacturing decisions, inventory management decisions, dealer actions, and direct customer interactions based on the potential demand.

In another aspect, the present disclosure is directed to a computer-implemented method. The method may include collecting by a computer processor road condition data for a road in one or more locations, collecting by the computer processor econometric data related to one or more entities responsible for maintenance of the road in the one or more locations, and collecting by the computer processor data related to historical responsiveness of the one or more entities in taking actions related to the maintenance of the road. The method may also include identifying by the computer processor one or more potential customers and a potential demand for certain types and respective quantities of the road repair equipment from the road condition data, the econometric data and the historical responsiveness data. The method may still further include implementing by the computer processor one or more of manufacturing decisions, inventory management decisions, dealer actions, and direct customer interactions based on the potential demand.

In yet another aspect, the present disclosure is directed to a non-transitory, computer-readable storage device storing instructions for forecasting demand for road repair equipment and implementing actions based on the forecasted demand. The instructions stored on the device may cause one or more computer processors to perform operations including collecting road condition data for a road in one or more locations, collecting econometric data related to one or more entities responsible for maintenance of the road in the one or more locations, and collecting data related to historical responsiveness of the one or more entities in taking actions related to the maintenance of the road. The instructions may also cause the one or more processors to identify one or more potential customers and a potential demand for one or more types and respective quantities of the road repair equipment from the road condition data, the econometric data and the historical responsiveness data. The instructions may still further cause the one or more processors to implement one or more of manufacturing decisions, inventory management decisions, dealer actions, and direct customer interactions based on the potential demand.

### BRIEF DESCRIPTION OF THE DRAWINGS

FIG. 1 illustrates an exemplary system for forecasting demand for road repair equipment and implementing actions based on the forecasted demand.

FIG. 2 illustrates an exemplary flowchart of a process of forecasting demand for road repair equipment and implementing actions based on the forecasted demand.

### DETAILED DESCRIPTION

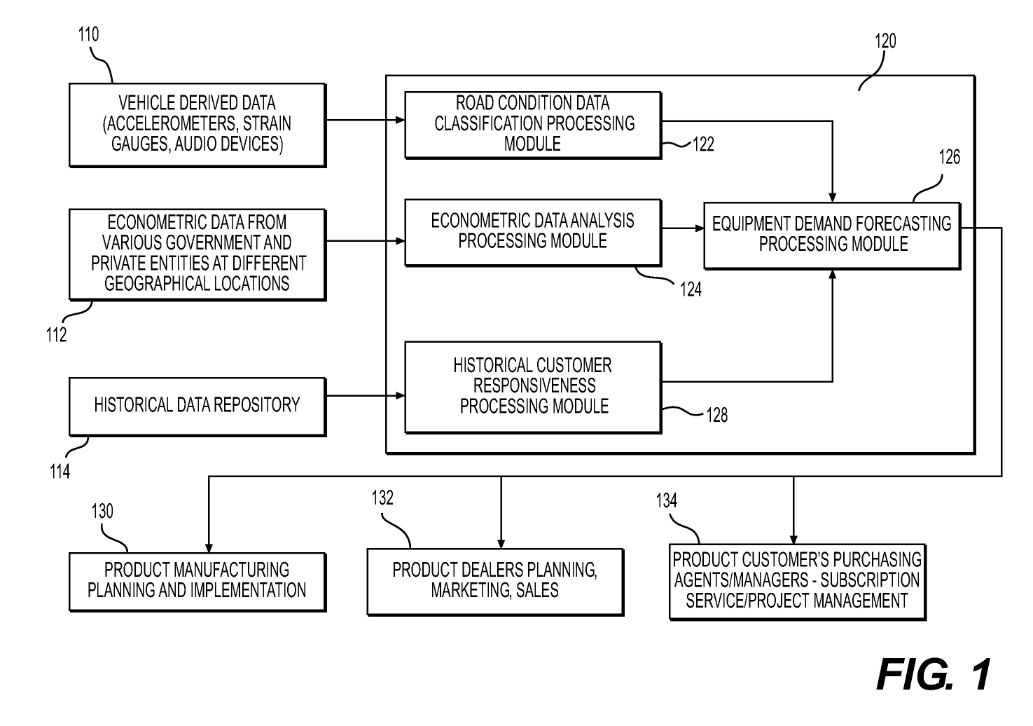

FIG. 1 illustrates an exemplary system in accordance with this disclosure. Vehicle-derived data 110 may be data indicative of the condition of a road at one or more locations. The vehicle-derived data may be included in an existing database of information created using one or more accelerometers, strain gauges, range finders, location sensors, audio devices, visual devices, or other types of sensors mounted on a plurality of vehicles traveling over the road. The accelerometers on the vehicles may be configured to measure sudden accelerations or gravitational forces on the vehicle caused as the vehicle runs over a pot hole, road waviness, road roughness, or other defect in a road over which the vehicle is traveling. Strain gauges on the vehicle, for example, may provide signals indicative of forces exerted on various portions of the vehicle when the vehicle runs over a pothole. Sensors such as range finders may provide signals indicative of a distance between a mounting point on the vehicle and a road surface, thereby also identifying defects in a road surface. Location sensors such as GPS sensors may provide signals indicative of the geographical location of defects such as potholes. Audio devices such as microphones and visual devices such as cameras may provide additional information regarding defects in a road surface.

The vehicles may be provided with the sensors and electronic processing technology that allow the vehicles to act as continuous data gathering units. Signals may be produced by multiple sensors provided on multiple vehicles of all different types traveling over a road. The signals may be processed onboard the vehicles, or transmitted to remote locations, processors, or servers for processing and storage. Crowd sourcing of this road condition data gathering over a large number of vehicles that are traveling over the road may provide a timely and accurate assessment of the overall road infrastructure condition for any given road anywhere in the world. Alternatively, a small number of vehicles could provide most of the information used to determine road conditions. The information collected by the vehicles may be sent to data warehouses or remote servers (e.g., cloud computing), and made available on an intermittent basis or as a continuing subscription, such as through a Data as a Service (DaaS) arrangement. The multiple sensors provided on a large number of vehicles traveling over roads at all different times, speeds, and locations may also provide redundancy of the collected data and the ability to verify and calibrate the different types of data that are gathered. For example, some emergency vehicles and commercial vehicles may be provided with sophisticated sensing technology and sensors that are regularly calibrated. Other vehicles such as passenger cars may include a variety of sensors that are not necessarily calibrated on a regular basis.

A processor configured to receive data from both calibrated sensors and non-calibrated sensors may be configured to include an automatic correction algorithm that determines a relationship between signals from the calibrated and non-calibrated sensors for the same location on a road. The processor may be configured to map the non-calibrated sensors to the calibrated sensors so that data from the non-calibrated sensors at different locations may be automatically corrected. A road condition data classification processing module 122, may be configured to perform these types of calibrations. The processing module 122 may be configured to obtain a first set of sensor data related to a first physical characteristic of the road at a first location from a set of calibrated sensors located on a plurality of vehicles traveling over the road at the first location. The processing module 122 may also be configured to obtain a second set of sensor data related to the first physical characteristic of the road at the first location from a set of non-calibrated sensors located on a plurality of vehicles traveling over the road at the first location. The processing module 122 may be still further configured to determine a relationship between the first set of sensor data and the second set of sensor data, and transform new sensor data related to a second physical characteristic of the road at a second location obtained from the non-calibrated sensors as a function of the determined relationship. As shown in FIG. 1, the processing module 122 may be part of one or more processors 120, and the one or more processors may be local or remote. The processing module 122 may also be configured to map a portion of a lane of the road containing a particular defect by analyzing the percentage of vehicles passing over the location that registers the defect.

In addition to the vehicle-derived data indicative of road conditions, econometric data 112 collected from various government and private entities at different geographical locations may also be provided. Econometric data 112 may include transportation budgets or other budget related data that are currently relevant for the various entities. Alternatively or in addition, econometric data 112 may represent a more global economic outlook, or the economic outlook of a given geographic region where a road is located. The entities of interest in the gathering of the econometric data 112 may be private entities, or local, municipal, state, or federal government entities responsible for the maintenance of the roads from which road condition data is being gathered. In various alternative implementations of this disclosure, the econometric data 112 may also include a wide variety of economic indicators in addition to budgetary constraints that may be relevant to the one or more entities responsible for maintaining the road. Exemplary econometric data may include gross domestic product (GDP) growth for a geographical area where a road is located, monthly industrial production indices of various industries in the geographical area, unemployment numbers for the population of an area, consumer sentiment, and other measures of the general economic well-being of a particular geographical area. The econometric data may also include monthly average prices of various raw materials such as, for example, crude oil, copper, gasoline, asphalt, concrete, and other materials. The econometric data may further include various construction indicators and other econometric indicators representative of the amount of traffic and type of traffic traveling over a particular road. The econometric data may be received by an econometric data analysis processing module 124, which may be part of one or more processors 120.

An historical data repository 114 may be included as a collection of data indicative of the historical responsiveness of a particular entity in implementing actions for the maintenance of roads discovered to have areas with road conditions that are below a certain threshold quality. Historical customer responsiveness data may indicate, for example, that a particular municipal government responsible for maintaining a section of road has historically taken action to repair potholes within the same quarter that the damage is reported. Data may be gathered over time for a number of different entities responsible for maintaining roads in different geographical areas. Road condition data may be provided to different entities on a continuing subscription basis as the entities realize a savings by recognizing a need for, and performing repair work sooner rather than later. The historical customer responsiveness data may be indicative of an average amount of time typically elapsed until actions are taken after a particular entity is made aware of a road condition falling below a certain threshold. The historical customer responsiveness data may be received by a historical customer responsiveness processing module 128, which may be part of one or more processors 120.

The data received and processed by the processing modules 122, 124, and 128 may be combined in an equipment demand forecasting processing module 126. The road condition data classification processing module 122 may be configured to classify a road in one or more locations based on the collected road condition data as falling within one of a plurality of road quality categories. The processing module 122 may also be configured to compare the one road quality category to a predetermined first threshold. For example, road quality categories may include poor, fair, good, and excellent. Alternative classification methodologies may also be based upon a numerical scale or other parameters. Locations on roads that are classified as falling within a fair category or higher may be eliminated from further consideration at the present time. Therefore, the road condition data for these locations may not be sent to the equipment demand forecasting processing module 126. One or more of the processing modules 122, 124, and 128 may also be configured to determine a rate of change of road conditions in one or more locations, and use that information to predict when the roads may need repairs.

The econometric data analysis processing module 124 may be configured to classify each of the one or more entities based on the econometric data as falling within a customer financial category representative of the likelihood each respective entity will initiate repairs of the one of more locations of the road. The processing module 124 may also be configured to compare each customer financial category to a predetermined second threshold. For example, customer financial categories may include low, medium, and high. Alternative classification methodologies may also be based upon a numerical scale or other parameters. Each customer financial category may be indicative of the current infrastructure maintenance budgets of a particular entity, the current growth in GDP for the geographical regions where the roads and the entities responsible for maintaining the roads are located, or other economic indicators. An entity, and accordingly the roads the entity is responsible for maintaining, may be eliminated from further consideration at the current time if the customer financial category of the entity falls below a predetermined second threshold. The economic data may provide significant enhancements to the forecasting model by focusing actions related to the manufacturing, marketing, and sales of road repair equipment on locations that have the highest likelihood of needing and receiving repair work.

The historical customer responsiveness processing module 128 may be configured to classify each of the one or more entities based on the data related to historical responsiveness as falling within a customer responsiveness category representative of the likelihood each respective entity will initiate repairs of the one or more locations of the road within a predetermined period of time. The processing module 128 may also be configured to compare each customer responsiveness category to a predetermined third threshold. For example, data may be gathered over a period of time for many entities responsible for maintaining roads, where the data shows how much time on average has elapsed between when each entity was informed of a road quality category below a certain threshold, and when each entity initiated actions for repair of the road.

The equipment demand forecasting processing module 126 may be configured to identify an area of interest based upon the road quality category being below the first threshold, the customer financial category being above the second threshold, and the customer responsiveness category being above the third threshold. The identified area of interest may be locations on roads that have poor enough quality to be good candidates for repair, as well as being roads that are maintained by entities likely to have the current economic resources and historical tendency to undergo the repair work. The processing module 126 may be further configured to determine the types of equipment and quantities of each type of equipment that would be used in performing the repair work. The processing module 126 may, for example, determine the types of equipment used in the repair work by reference to proprietary or non-proprietary databases based on the capabilities of a particular manufacturer's machines and other engineering information in conjunction with the types of detected defects in the road.

The output from equipment demand forecasting processing module 126 may be provided as specific instructions that may be relayed to product manufacturing, planning, and implementation module 130 at a manufacturer, to product dealers, planning, marketing, or sales organizations 132, and to product customer's purchasing agents/managers, subscription service, and project management 134. Instructions provided to the manufacturer may be configured to control automated, or semi-automated manufacturing operations on a just-in-time manufacturing basis. The output from processing module 126 may allow a manufacturer to target manufacturing efforts for the types and quantities of equipment and spare parts that will be the most likely to be needed based on forecasted repair work. The output from processing module 126 may also provide dealers of the equipment with a significant competitive advantage by allowing the dealers to plan the correct inventory needed for potential projects. Dealers and other marketing and sales organizations with access to the information provided by processing module 126 may be able to plan ahead and offer better prices for the equipment that may be leased or purchased to perform the upcoming repair work. The information provided from each of the road condition, econometric data analysis, and historical customer responsiveness processing modules may also enable the equipment demand forecasting processing module 126 to provide alternative scenarios to potential customers that may not currently have the financial means to purchase new equipment. These alternative scenarios may include proposals for various private or government entities to enter into a service contract model, in which they will lease equipment as needed to maintain their roads at acceptable levels.

The processor 120 in FIG. 1 may be a server, client, mainframe, desktop, laptop, network computer, workstation, personal digital assistant (PDA), tablet PC, distributed computing architecture, or the like. In one embodiment, the processor 120 may be a computer including one or more processing devices. The processor 120 may be communicatively coupled to various data storage units, memory devices, I/O devices, and network interfaces. Each of the processing modules of the processor 120 may be configured to execute computer program instructions to perform various processes and methods consistent with certain disclosed embodiments. The computer program instructions for forecasting demand for road repair equipment and implementing actions based on the forecasted demand may be stored on a non-transitory computer-readable storage device.

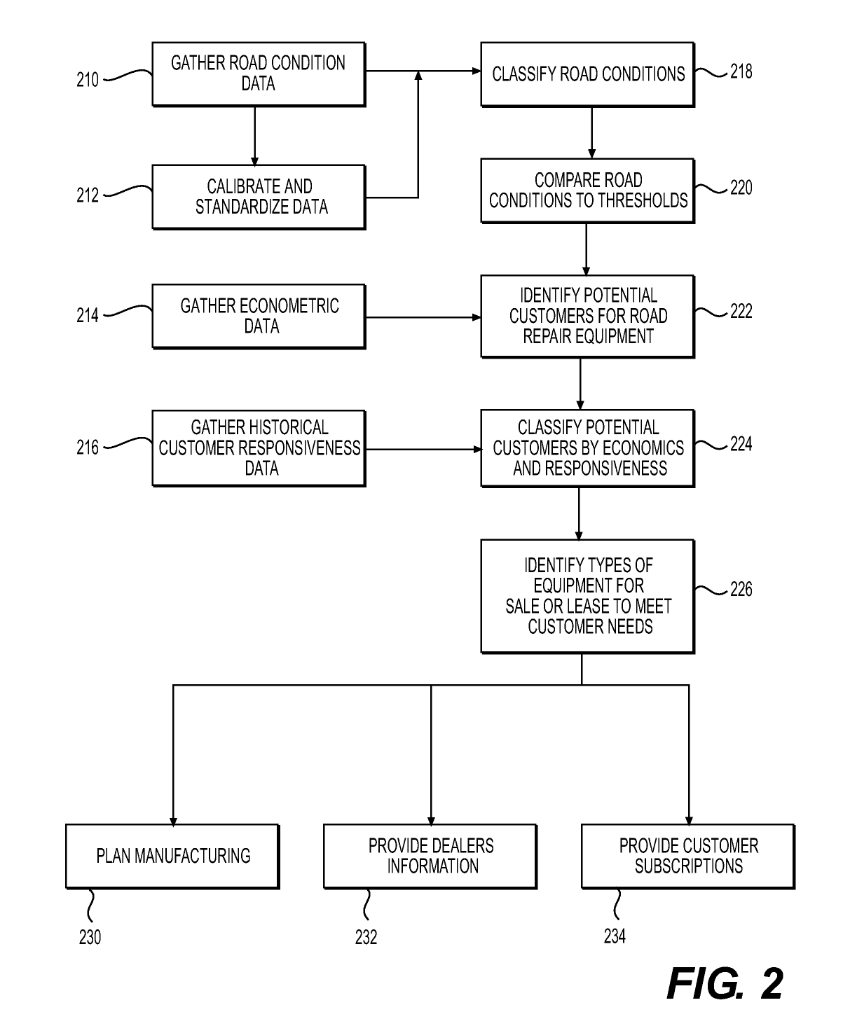

A flowchart illustrating exemplary method steps for forecasting demand for road repair equipment and implementing actions based on the forecasted demand is shown in FIG. 2. The details of FIG. 2 will be described in the following section.

### INDUSTRIAL APPLICABILITY

Methods, systems, and articles of manufacture consistent with features related to the disclosed embodiments allow a system to forecast demand for road repair equipment and implement actions based on the forecasted demand. Various implementations of this disclosure combine crowd sourced data gathered from a plurality of vehicles that include sensors for measuring road surface conditions, with customer-centric data. The road condition data may provide an accurate and timely assessment of the overall road infrastructure condition for any road in the world. Wireless interconnectivity and the availability of affordable sensors and data plans associated with the vehicles enable the vehicles to become continuous data gathering units. The vehicles may come equipped with a variety of sensors capable of communicating real time data indicative of environmental conditions and operational characteristics. Combining the road condition data received from a large number of vehicles traveling over a road with economic data associated with the entity responsible for maintaining the road may provide a valuable new source of information for manufacturers, dealers, and customers of the equipment used in repairing the road.

As shown in FIG. 2, a method in accordance with one exemplary implementation of this disclosure may include gathering road condition data at step: 210. As explained above, the road condition data may be derived from various sensors mounted on vehicles traveling over the road. The sensors may include both calibrated and non-calibrated sensors, such as acceleration sensors, strain gauges, range finders, location sensors, visual sensors, and audio sensors mounted on each of a plurality of vehicles.

The road condition data from step: 210 may be calibrated and standardized at step: 212. In one exemplary implementation, a computer processing module may obtain a first set of sensor data related to a first physical characteristic of the road at a first location from a set of calibrated sensors located on a plurality of vehicles traveling over the road at the first location. The computer processing module may also obtain a second set of sensor data related to the first physical characteristic of the road at the first location from a set of non-calibrated sensors located on a plurality of vehicles traveling over the road at the first location. The computer processing module may then determine a difference between the first set of sensor data and the second set of sensor data. For example, the processing module may determine that the second set of sensor data from a set of non-calibrated sensors consistently underestimates the actual size of the pothole by approximately 10%. This deviation from the first set of sensor data received from a set of calibrated sensors may be a result of various factors including the differences in suspension components for different vehicles, the average speeds at which the vehicles are driving, and the weights of the vehicles. Once enough data from both calibrated and non-calibrated sensors has been gathered in relation to a particular physical characteristic of the road, the processing module may establish the relationship between the sets of data, such as by determining the difference between the sets of data. The processing module may then use this predetermined difference to transform new sensor data retrieved by the non-calibrated sensors in relation to other physical characteristics.

The road condition data gathered at step: 210 and calibrated and standardized at step: 212 may then be classified at step: 218. The road conditions at different locations may be classified based on the collected road condition data as falling within one of a plurality of road quality categories. Examples of road quality categories may include poor, fair, good, and excellent. Alternative road quality categories may be based on a numerical scale or other categories. Once the road has been classified in accordance with its measured quality, the road quality category may be compared to a predetermined first threshold at step: 220. In some implementations, for example, only road locations that fall within a road quality category that is poor may be further analyzed.

Econometric data may also be gathered at step: 214. A computer processor may collect the econometric data related to one or more entities responsible for maintenance of the road. As discussed above, the econometric data may include budgetary constraints currently being experienced by the entities, or other economic factors that may affect the likelihood a particular entity will be interested in directly buying or leasing road repair equipment, or contracting out to other potential customers for road repair jobs. Potential customers for road repair equipment may be identified at step: 222. Roads that fall under the maintenance responsibility of particular entities may be continuously monitored and the econometric data associated with the particular entities may be continuously updated in order to provide immediate notification of new potential customers as economic conditions change.

Historical customer responsiveness data may also be gathered at step: 216. In particular, a computer processor may collect data related to the historical responsiveness of one or more entities or other potential customers in taking actions related to the maintenance of the roads. The responsiveness may be related to an average time elapsed between when an entity is first made aware of one or more locations on a road falling below a threshold quality category and when repair actions are taken.

Potential customers such as the entities responsible for the maintenance of the roads, and the contractors who receive contracts for repair of the roads may be classified at step: 224 based on both economic factors and historical responsiveness. In some exemplary implementations, one or more entities may be classified based on the econometric data falling within a customer financial category representative of the likelihood each respective entity will initiate repairs of one or more locations on the road. The computer processor may compare each customer financial category to a predetermined second threshold. Potential customers that fall within a financial category above the second threshold may be the most likely to be interested in purchasing new equipment to handle road repair jobs. Potential customers falling within a financial category above the second threshold may also be the entities responsible for maintenance of the roads who are the most likely to employ a construction company to carry out the road repair jobs. The construction company or companies that are awarded contracts by these entities may in turn become the potential customers most likely to be interested in purchasing or leasing road repair equipment. The computer processor may also take a variety of economic factors into consideration that may be indicative of an economic upturn and an increased likelihood that a potential customer may be interested in at least temporarily leasing the equipment. The computer processor may also classify each of the entities or other potential customers based on the data related to historical responsiveness falling within a customer responsiveness category representative of the likelihood each respective entity or other potential customer will initiate repairs of the one or more locations of the road within a predetermined period of time. The computer processor may also compare each customer responsiveness category to a predetermined third threshold.

After having gathered and classified the road quality data, the customer financial data, and the customer responsiveness data, the computer processor may identify an area of interest based upon the road quality category being below the first threshold, the customer financial category being above the second threshold, and the customer responsiveness category being above the third threshold. At step: 226 the computer processor may identify certain types of equipment for sale or lease to meet customer needs in the area of interest. Searches for the identified areas of interest may be initiated by a customer input such as zip code and radius for nearby roads. Potential customers such as construction contractors, as well as dealers of the road repair equipment may be examples of entities that may be interested in subscribing to the output from the computer processor in order to perform these types of searches for identified areas of interest.

The output from the computer processor after having identified the types and quantities of equipment that may be useful in performing the road repairs on roads that have a quality below a threshold, and the potential customers, may be instructions or information transmitted to a manufacturer, a dealer, or a customer. At step: 230, specific instructions may be provided to a manufacturer to assist in planning various manufacturing operations. The current assessment of potential demand for certain types and quantities of equipment based on all of the factors discussed above may allow the manufacturer to prepare for increased orders, make inventory management decisions, implement engineering or design changes, and otherwise implement just-in-time manufacturing protocols.

At step: 232, dealers of the road repair equipment may be provided with information that makes them aware of potential rental, lease, or sales opportunities in the identified area of interest. As a result, the dealers may gain a competitive advantage by being stocked with the types and quantities of equipment needed by potential customers for upcoming road repair projects. The information may also give the dealers a head start over their competition in approaching potential customers and closing business deals quickly based on their knowledge of their customer needs.

At step: 234, potential customers may be provided with subscriptions to the output of the above-described series of computer-implemented steps. These subscriptions may provide customers such as highway contractors or other contractors who perform the road repair work with a competitive advantage over other customers. The subscription service may provide the contractors with advanced notice of potential work in an area of interest. Other subscription customers such as the private or government entities responsible for maintaining the roads may be made aware of the potential savings that could be achieved by performing road repair work sooner rather than later. Additional business options for the subscription customers may also include service contracts that allow an entity to maintain the roads under their jurisdiction at an acceptable level while avoiding any large and unexpected expenditures.

It will be apparent to those skilled in the art that various modifications and variations can be made to the disclosed systems and methods for forecasting demand for equipment used in repairing roads and other infrastructure. Other embodiments will be apparent to those skilled in the art from consideration of the specification and practice of the disclosed forecasting system. It is intended that the specification and examples be considered as exemplary only, with a true scope being indicated by the following claims and their equivalents.

What is claimed is:

1. A computer system for forecasting demand for road repair equipment and implementing actions based on the forecasted demand, the computer system comprising:
at least one processor configured to:
collect road condition data for a road in one or more locations;
collect econometric data related to one or more entities responsible for maintenance of the road in the one or more locations;
collect data related to historical responsiveness of the one or more entities in taking actions related to the maintenance of the road;
identify one or more potential customers and a potential demand for certain types and respective quantities of the road repair equipment from the road condition data, the econometric data and the historical responsiveness data; and
implement one or more of manufacturing decisions, inventory management decisions, dealer actions, and direct customer interactions based on the potential demand.

2. The computer system of claim 1, wherein the at least one processor is further configured to:
collect the road condition data for a road in one or more locations by:
obtaining a first set of sensor data related to a first physical characteristic of the road at a first location from a set of calibrated sensors located on a plurality of vehicles traveling over the road at the first location;
obtaining a second set of sensor data related to the first physical characteristic of the road at the first location from a set of non-calibrated sensors located on a plurality of vehicles traveling over the road at the first location;
determining a relationship between the first set of sensor data and the second set of sensor data; and
transforming new sensor data related to a second physical characteristic of the road at a second location obtained from the non-calibrated sensors as a function of the determined relationship.

3. The computer system of claim 1, wherein the at least one processor is configured to collect the road condition data from at least one of acceleration sensors, strain gauges, range finders, location sensors, visual sensors, and audio sensors mounted on each of a plurality of vehicles traveling along the road.

4. The computer system of claim 3, wherein the at least one processor is further configured to automatically correct road condition data collected by non-calibrated sensors mounted on vehicles passing over the road in a first location as a function of a predetermined difference between road condition data collected by calibrated sensors mounted on vehicles passing over the road in a second location and road condition data collected by the non-calibrated sensors mounted on vehicles passing over the road in the second location.

5. The computer system of claim 1, wherein the at least one processor is further configured to:
classify the road in the one or more locations based on the collected road condition data as falling within one of a plurality of road quality categories; and
compare the one of a plurality of road quality categories to a predetermined first threshold.

6. The computer system of claim 1, wherein the at least one processor is further configured to:
classify each of the one or more entities based on the econometric data as falling within a customer financial category representative of the likelihood each respective entity will initiate repairs of the one or more locations of the road; and
compare each customer financial category to a predetermined second threshold.

7. The computer system of claim 1, wherein the at least one processor is further configured to:
classify each of the one or more entities based on the data related to historical responsiveness as falling within a customer responsiveness category representative of the likelihood each respective entity will initiate repairs of the one or more locations of the road within a predetermined period of time; and
compare each customer responsiveness category to a predetermined third threshold.

8. The computer system of claim 5, wherein the at least one processor is further configured to:
classify each of the one or more entities based on the econometric data as falling within a customer financial category representative of the likelihood each respective entity will initiate repairs of the one or more locations of the road;
compare each customer financial category to a predetermined second threshold;
classify each of the one or more entities based on the data related to historical responsiveness as falling within a customer responsiveness category representative of the likelihood each respective entity will initiate repairs of the one or more locations of the road within a predetermined period of time;
compare each customer responsiveness category to a predetermined third threshold; and
identify an area of interest based upon the road quality category being below the first threshold, the customer financial category being above the second threshold, and the customer responsiveness category being above the third threshold.

9. The computer system of claim 8, wherein the at least one processor is configured to implement the one or more of manufacturing decisions, inventory management decisions, dealer actions, and direct customer interactions as a function of demand for one or more types and respective quantities of the road repair equipment useful in performing the maintenance of the road in the identified area of interest.

10. A computer-implemented method, comprising:
collecting by a computer processor road condition data for a road in one or more locations;
collecting by the computer processor econometric data related to one or more entities responsible for maintenance of the road in the one or more locations;
collecting by the computer processor data related to historical responsiveness of the one or more entities in taking actions related to the maintenance of the road;
identifying by the computer processor one or more potential customers and a potential demand for certain types and respective quantities of road repair equipment from the road condition data, the econometric data, and the historical responsiveness data; and
implementing by the computer processor one or more of manufacturing decisions, inventory management decisions, dealer actions, and direct customer interactions based on the potential demand.

11. The computer-implemented method of claim 10, wherein collecting road condition data for a road in one or more locations is performed by:
obtaining by the computer processor a first set of sensor data related to a first physical characteristic of the road at a first location from a set of calibrated sensors located on a plurality of vehicles traveling over the road at the first location;
obtaining by the computer processor a second set of sensor data related to the first physical characteristic of the road at the first location from a set of non-calibrated sensors located on a plurality of vehicles traveling over the road at the first location;
determining by the computer processor a relationship between the first set of sensor data and the second set of sensor data; and
transforming by the computer processor new sensor data related to a second physical characteristic of the road at a second location obtained from the non-calibrated sensors as a function of the determined relationship.

12. The computer-implemented method of claim 10, wherein collecting road condition data comprises collecting data from at least one of acceleration sensors, strain gauges, range finders, location sensors, visual sensors, and audio sensors mounted on each of a plurality of vehicles traveling along the road.

13. The computer-implemented method of claim 12, further including automatically correcting road condition data collected by non-calibrated sensors mounted on vehicles passing over the road in a first location as a function of a predetermined difference between road condition data collected by calibrated sensors mounted on vehicles passing over the road in a second location and road condition data collected by the non-calibrated sensors mounted on vehicles passing over the road in the second location.

14. The computer-implemented method of claim 10, further including:
classifying the road in the one or more locations based on the collected road condition data as falling within one of a plurality of road quality categories; and
comparing the one road quality category to a predetermined first threshold.

15. The computer-implemented method of claim 10, further including:
classifying each of the one or more entities based on the econometric data as falling within a customer financial category representative of the likelihood each respective entity will initiate repairs of the one or more locations of the road; and
comparing each customer financial category to a predetermined second threshold.

16. The computer-implemented method of claim 10, further including:
classifying each of the one or more entities based on the data related to historical responsiveness as falling within a customer responsiveness category representative of the likelihood each respective entity will initiate repairs of the one or more locations of the road within a predetermined period of time; and
comparing each customer responsiveness category to a predetermined third threshold.

17. The computer-implemented method of claim 14, further including:
classifying each of the one or more entities based on the econometric data as falling within a customer financial category representative of the likelihood each respective entity will initiate repairs of the one or more locations of the road;
comparing each customer financial category to a predetermined second threshold;
classifying each of the one or more entities based on the data related to historical responsiveness as falling within a customer responsiveness category representative of the likelihood each respective entity will initiate repairs of the one or more locations of the road within a predetermined period of time;
comparing each customer responsiveness category to a predetermined third threshold; and
identifying an area of interest based upon the road quality category being below the first threshold, the customer financial category being above the second threshold, and the customer responsiveness category being above the third threshold.

18. The computer-implemented method of claim 17, further including implementing the one or more of manufacturing decisions, inventory management decisions, dealer actions, and direct customer interactions as a function of demand for one or more types and respective quantities of the road repair equipment useful in performing the maintenance of the road in the identified area of interest.

19. A non-transitory computer-readable storage device storing instructions for forecasting demand for road repair equipment and implementing actions based on the forecasted demand, the instructions causing one or more computer processors to perform operations comprising:
collecting road condition data for a road in one or more locations;
collecting econometric data related to one or more entities responsible for maintenance of the road in the one or more locations;
collecting data related to historical responsiveness of the one or more entities in taking actions related to the maintenance of the road;
identifying one or more potential customers and a potential demand for one or more types and respective quantities of the road repair equipment from the road condition data, the econometric data, and the historical responsiveness data; and
implementing one or more of manufacturing decisions, inventory management decisions, dealer actions, and direct customer interactions based on the potential demand.

20. The non-transitory computer-readable storage device of claim 19, further storing instructions causing the one or more computer processors to perform operations comprising:
classifying the road in the one or more locations based on the collected road condition data as falling within one of a plurality of road quality categories;
comparing the one road quality category to a predetermined first threshold;
classifying each of the one or more entities based on the econometric data as falling within a customer financial category representative of the likelihood each respective entity will initiate repairs of the one or more locations of the road;
comparing each customer financial category to a predetermined second threshold;
classifying each of the one or more entities based on the data related to historical responsiveness as falling within a customer responsiveness category representative of the likelihood each respective entity will initiate repairs of the one or more locations of the road within a predetermined period of time;
comparing each customer responsiveness category to a predetermined third threshold; and
identifying an area of interest for implementing one or more of manufacturing decisions, inventory management decisions, dealer actions, and direct customer interactions based upon the road quality category being below the first threshold, the customer financial category being above the second threshold, and the customer responsiveness category being above the third threshold.
